(19) United States
(12) Patent Application Publication
(10) Pub. No.: US 2024/0260012 A1
(43) Pub. Date: Aug. 1, 2024

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/586,594

(22) Filed: Feb. 26, 2024

Related U.S. Application Data
(63) Continuation of application No. PCT/CN2022/113218, filed on Aug. 18, 2022.

(30) Foreign Application Priority Data
Aug. 27, 2021 (CN) 202110994671.4

(51) Int. Cl. H04W 72/0446; H04L 5/14; H04W 52/34

(52) U.S. Cl. CPC H04W 72/0446; H04L 5/14; H04W 52/34

(57) ABSTRACT

A first node receives a first signaling and a second signaling; transmits a first sub-signal set. The first signaling is used to determine a first time-domain resource; the second signaling is used to determine a first time window set; the first time window set comprises at least one first-type time window; the first time window set is used to determine a second time window set, and the second time window set comprises at least one second-type time window; how many second-type time windows in the second time window set are comprised by the given first-type time window is related to whether the given first-type time window comprises both a symbol belonging to the first time-domain resource and a symbol belonging to the second time-domain resource. The above method supports independent selection of transmit parameters and independent decoding for different duplex modes.

### CROSS REFERENCE TO RELATED APPLICATIONS

This application is the continuation of the international patent application No. PCT/CN2022/113218, filed on Aug. 18, 2022, which claims the priority benefit of Chinese Patent Application No. 202110994671.4, filed on Aug. 27, 2021, the full disclosure of which is incorporated herein by reference.

### BACKGROUND

### Technical Field

The present application relates to transmission methods and devices in wireless communication systems, and in particular to a transmission scheme and device for flexible transmission direction configuration in wireless communications.

### Related Art

Application scenarios of future wireless communication systems are becoming increasingly diversified, and different application scenarios have different performance demands on systems. In order to meet different performance requirements of multiple application scenarios, it was decided at #72nd plenary of 3GPP (3rd Generation Partner Project) RAN (Radio Access Network) that NR (New Radio) (or 5G) systems would be studied. A WI (Work Item) for NR was adopted at 3GPP RAN #75-th plenary to start standardization work on NR. It was decided at 3GPP RAN #86-th plenary to start a work on the SI (Study Item) and WI for NR R (release)-17 and it is expected that the SI and WI for NR R-18 will be projected at 3GPP RAN #94e-th plenary.

Compared with conventional 3rd Generation Partner Project (3GPP) Long-term Evolution (LTE) system, NR system supports more diverse application scenarios, such as enhanced Mobile BroadBand (eMBB), Ultra-Reliable and Low Latency Communications (URLLC), and massive Machine-Type Communications (mMTC). Compared with other application scenarios, URLLC puts forward higher requirements for transmission reliability and delay. 3GPP R15 and R16 support the use of repetition to improve transmission reliability.

### SUMMARY

In existing NR systems, spectrum resources are statically divided into FDD spectrum and TDD spectrum. For the TDD spectrum, both the base station and User Equipment (UE) operate in half-duplex mode. This half-duplex mode avoids self-interference and can mitigate the impact of Cross Link interference, but also brings about a decrease in resource utilization and an increase in latency. For these problems, supporting flexible duplex mode or variable link orientation (up or down or flexible) on the TDD spectrum or FDD spectrum becomes a possible solution. Supporting a more flexible duplex mode or full duplex mode in NR R-18 has received a lot of attention and discussion in 3GPP RAN #88e-th meeting and 3GPP R-18 workshop. Communications in this mode is subject to severe interference, both self-interference and cross-link interference. To solve the interference problem, advanced interference cancellation techniques are required, comprising antenna isolation, beamforming, RF (Radio Frequency) level interference cancellation and digital interference cancellation.

In a PUSCH (Physical Uplink Shared CHannel) repetition mechanism of R16, the UE determines time-domain resources occupied by each actual transmission according to the actual situation, i.e., divides allocated time resources into multiple actual repetitions. What effect a more flexible duplex mode would have on the division of actual repetitions is a question that needs to be addressed.

To address the above problem, the present application provides a solution. It should be noted that while the above description uses more flexible duplex/full duplex modes and cellular networks as examples, the present application is also applicable to other scenarios such as other duplex modes or variable link direction techniques, V2X (Vehicle-to-Everything) and sidelink transmissions, where similar technical effects can be achieved. In addition, adopting a unified solution for different scenarios (including but not limited to more flexible duplex/full duplex, other duplex modes or variable link direction techniques, cellular networks, V2X, and sidelink transmission) can also help reduce hardware complexity and costs. If no conflict is incurred, embodiments in a first node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling, the first signaling being used to determine a first time-domain resource;
receiving a second signaling, the second signaling being used to determine a first time window set; and
transmitting a first sub-signal set, the first sub-signal set comprising at least one sub-signal, and any sub-signal in the first sub-signal set carrying a first bit block;
herein, the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

In one embodiment, a problem to be solved in the present application comprises: in the more flexible duplex or full-duplex modes, how to determine time resources occupied by each actual repetition. The above method solves this problem by determining which symbols can be used for a same actual repetition based on the corresponding duplex mode of each symbol.

In one embodiment, characteristics of the above method comprise: symbols in the first time-domain resource are in a more flexible duplex mode or full duplex mode, and symbols in the second time-domain resource are uplink symbols in a half-duplex mode; the second-type time window is a repetition; a repetition cannot comprise both symbols in the more flexible duplex mode or full-duplex mode and symbols in half-duplex mode.

In one embodiment, advantages of the above method comprise: for signals in more flexible duplex mode or full-duplex mode and signals in half-duplex mode, transmission parameters can be independently selected, including but not limited to transmit power, QCL (Quasi Co-Located) parameters, MCS (Modulation and Coding Scheme), etc., to respectively meet the needs of different duplex modes.

In one embodiment, advantages of the above method comprise: signals in the more flexible duplex mode or full-duplex mode and signals in half-duplex mode can be decoded independently; more advanced interference cancellation techniques are adopted for signals in the more flexible duplex or full-duplex modes, and conventional interference cancellation techniques are used for signals in the half-duplex mode; it meets the need for interference cancellation in more flexible duplex or full-duplex mode while avoiding unnecessary increase in the processing complexity of signals in the half-duplex mode.

According to one aspect of the present application, it is characterized in that the first signaling configures a symbol in the first time-domain resource as a first type.

According to one aspect of the present application, it is characterized that a first sub-signal is a sub-signal transmitted in a first time window in the first sub-signal set, and the first time window is any second-type time window in the second time window set; a redundancy version (RV) of the first sub-signal is related to an index of the first time window.

According to one aspect of the present application, it is characterized that a given sub-signal is any sub-signal in the first sub-signal set, and the first node maintains power consistency on the given sub-signal.

According to one aspect of the present application, it is characterized that a second time window and a third time window are respectively two second-type time windows in the second time window set, and the second time window and the third time window belong to a same first-type time window in the first time window set; a second sub-signal and a third sub-signal are respectively sub-signals transmitted in the second time window and the third time window in the first sub-signal set; the second sub-signal and the third sub-signal are not quasi co-located.

According to one aspect of the present application, it is characterized that a first sub-signal is a sub-signal transmitted in a first time window in the first sub-signal set, and the first time window is any second-type time window in the second time window set; a first power parameter set is used to calculate transmit power of the first sub-signal; the first power parameter set is related to whether the first time window comprises a symbol belonging to the first time-domain resource or a symbol belonging to the second time-domain resource.

In one embodiment, advantages of the above method comprise: flexibly adjusting uplink power control parameters according to the duplex mode to meet the different power requirements of full duplex and half duplex.

According to one aspect of the present application, it is characterized in that the first node is a UE.

According to one aspect of the present application, it is characterized in that the first node is a relay node.

The present application provides a method in a second node for wireless communications, comprising:
transmitting a first signaling, the first signaling being used to determine a first time-domain resource;
transmitting a second signaling, the second signaling being used to determine a first time window set; and
receiving a first sub-signal set, the first sub-signal set comprising at least one sub-signal, and any sub-signal in the first sub-signal set carrying a first bit block;
herein, the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

According to one aspect of the present application, it is characterized in that the first signaling configures a symbol in the first time-domain resource as a first type.

According to one aspect of the present application, it is characterized that a first sub-signal is a sub-signal transmitted in a first time window in the first sub-signal set, and the first time window is any second-type time window in the second time window set; a redundancy version (RV) of the first sub-signal is related to an index of the first time window.

According to one aspect of the present application, it is characterized that a given sub-signal is any sub-signal in the first sub-signal set, and a transmitter of the first sub-signal set maintains power consistency on the given sub-signal.

According to one aspect of the present application, it is characterized that a second time window and a third time window are respectively two second-type time windows in the second time window set, and the second time window and the third time window belong to a same first-type time window in the first time window set; a second sub-signal and a third sub-signal are respectively sub-signals transmitted in the second time window and the third time window in the first sub-signal set; the second sub-signal and the third sub-signal are not quasi co-located.

According to one aspect of the present application, it is characterized that a first sub-signal is a sub-signal transmitted in a first time window in the first sub-signal set, and the first time window is any second-type time window in the second time window set; a first power parameter set is used to calculate transmit power of the first sub-signal; the first power parameter set is related to whether the first time window comprises a symbol belonging to the first time-domain resource or a symbol belonging to the second time-domain resource.

According to one aspect of the present application, it is characterized in that the second node is a base station.

According to one aspect of the present application, it is characterized in that the second node is a UE.

According to one aspect of the present application, it is characterized in that the second node is a relay node.

The present application provides a first node for wireless communication, comprising:
a first receiver, receiving a first signaling and a second signaling, the first signaling being used to determine a first time-domain resource, the second signaling being used to determine a first time window set; and
a first transmitter, transmitting a first sub-signal set, the first sub-signal set comprising at least one sub-signal, and any sub-signal in the first sub-signal set carrying a first bit block;
herein, the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

The present application provides a second node for wireless communications, comprising:
a second transmitter, transmitting a first signaling and a second signaling, the first signaling being used to determine a first time-domain resource, the second signaling being used to determine a first time window set; and
a second receiver, receiving a first sub-signal set, the first sub-signal set comprising at least one sub-signal, and any sub-signal in the first sub-signal set carrying a first bit block;
herein, the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

In one embodiment, the present application has the following advantages over conventional schemes:
for signals in more flexible duplex mode or full-duplex mode and signals in half-duplex mode, transmitting parameters can be independently selected, including but not limited to transmit power, QCL parameters, MCS, etc., to respectively meet the needs of different duplex modes.
signals in the more flexible duplex mode or full-duplex mode and signals in half-duplex mode are decoded independently; it meets the need for interference cancellation in more flexible duplex or full-duplex mode, while avoiding unnecessary increase in the processing complexity of signals in half-duplex mode.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first signaling, a second signaling and a first sub-signal set according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of transmission according to one embodiment of the present application;

FIG. 6 illustrates a schematic diagram of a first-type time window according to one embodiment of the present application;

FIG. 7 illustrates a schematic diagram of a second-type time window according to one embodiment of the present application;

FIG. 8 illustrates a schematic diagram of a given first-type time window comprising a second-type time window according to one embodiment of the present application;

FIG. 9 illustrates a schematic diagram of a first signaling configuring a symbol in a first time-domain resource as a first type according to one embodiment of the present application;

FIG. 10 illustrates a schematic diagram of an RV of a first sub-signal being related to an index of a first time window according to one embodiment of the present application;

FIG. 11 illustrates a schematic diagram of a first node maintaining consistent power to a given sub-signal according to one embodiment of the present application;

FIG. 12 illustrates a schematic diagram of a second time window, a third time window, a second sub-signal and a third sub-signal according to one embodiment of the present application;

FIG. 13 illustrates a schematic diagram of transmit power of a first sub-signal according to one embodiment of the present application;

FIG. 14 illustrates a schematic diagram of a first power parameter set being related to whether a first time window comprises symbols belonging to a first time-domain resource or symbols belonging to the second time-domain resource according to an embodiment of the present application;

FIG. 15 illustrates a structure block diagram of a processor in a first node according to one embodiment of the present application;

FIG. 16 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

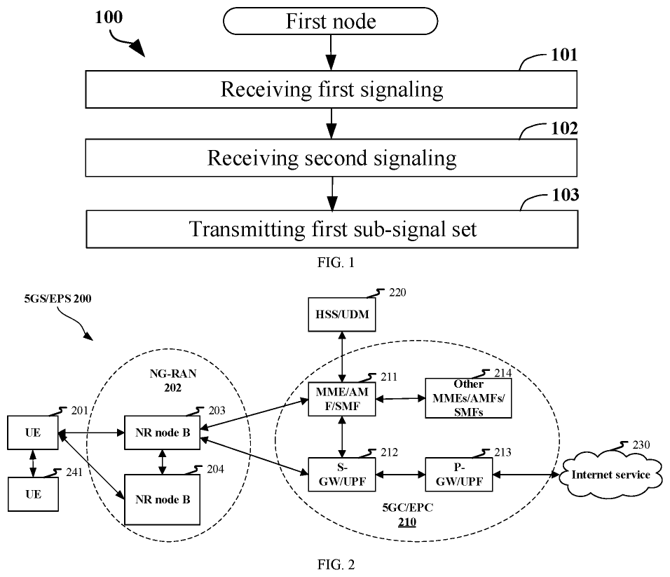

Embodiment 1 illustrates a flowchart of a first signaling, a second signaling and a first sub-signal set according to one embodiment of the present application, as shown in FIG. 1. In step 100 illustrated by FIG. 1, each box represents a step. And in particular, the order of steps in boxes does not represent chronological order of characteristics between the steps.

In Embodiment 1, the first node in the present application receives a first signaling in step 101; receives a second signaling in step 102; transmits a first sub-signal in step 103. Herein, the first signaling is used to determine a first time-domain resource; the second signaling is used to determine a first time window set; the first time window set comprises at least one first-type time window; the first time window set is used to determine a second time window set, and the second time window set comprises at least one second-type time window; the first sub-signal set comprises at least one sub-signal, and any sub-signal in the first sub-signal set carries a first bit block; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

In one embodiment, the first signaling comprises a higher-layer signaling.

In one embodiment, the first signaling comprises a Radio Resource Control (RRC) signaling.

In one embodiment, the first signaling comprises information in all or partial fields in a TDD-UL-DL-ConfigCommon IE.

In one embodiment, the first signaling comprises information in all or partial fields in a TDD-UL-DL-ConfigDedicated IE.

In one embodiment, the first signaling is carried by an IE (Information Element).

In one embodiment, a name of an IE carrying the first signaling comprises “TDD-UL-DL”.

In one embodiment, a name of an IE carrying the first signaling comprises “TDD-UL-DL-Config”.

In one embodiment, the first signaling comprises a Medium Access Control layer Control Element (MAC CE).

In one embodiment, the first signaling comprises a physical-layer signaling.

In one embodiment, the first signaling comprises a layer 1 (L1) signaling.

In one embodiment, the first signaling comprises Downlink Control Information (DCI).

In one embodiment, the first signaling is DCI.

In one embodiment, the first signaling comprises one or more fields in a DCI.

In one embodiment, the first signaling is a DCI, and a format of the first signaling is DCI format 2_0.

In one embodiment, the first signaling comprises being carried together by a higher-layer signaling and a physical-layer signaling.

In one embodiment, the first signaling only applies to a serving cell to which the first sub-signal set belongs.

In one embodiment, the first signaling only applies to a BWP (BandWidth Part) to which the first sub-signal set belongs.

In one embodiment, the first signaling is used to determine the first time-domain resource in a serving cell to which the first sub-signal set belongs.

In one embodiment, the first signaling is used to determine the first time-domain resource in a BWP to which the first sub-signal set belongs.

In one embodiment, the first time-domain resource comprises at least one symbol.

In one embodiment, the first time-domain resource comprises one symbol.

In one embodiment, the first time-domain resource comprises multiple continuous symbols.

In one embodiment, the first time-domain resource comprises multiple discontinuous symbols.

In one embodiment, the first time-domain resource comprises at least one slot.

In one embodiment, the first time-domain resource comprises at least one subframe.

In one embodiment, the second time-domain resource comprise at least one symbol.

In one embodiment, the second time-domain resource comprise one symbol.

In one embodiment, the second time-domain resource comprises multiple continuous symbols.

In one embodiment, the second time-domain resource comprises multiple discontinuous symbols.

In one embodiment, the second time-domain resource comprise at least one slot.

In one embodiment, the second time-frequency resource group comprises at least one sub-frame in time domain.

In one embodiment, the first time-domain resource and the second time-domain resource are orthogonal to each other.

In one embodiment, the first time-domain resource and the second time-domain resource are overlapping.

In one embodiment, there does not exist a symbol belonging to both the first time-domain resource and the second time-domain resource.

In one embodiment, the symbol comprises an Orthogonal Frequency Division Multiplexing (OFDM) symbol.

In one embodiment, the symbol comprises a Discrete Fourier Transform Spread OFDM (DFT-S-OFDM) symbol.

In one embodiment, a transmitter of the first signaling receives and transmits radio signals in the first time-domain resource simultaneously.

In one embodiment, a transmitter of the first signaling receives and transmits radio signals in a serving cell to which the first sub-signal set belongs in the first time-domain resource simultaneously.

In one embodiment, a transmitter of the first signaling receives and transmits radio signals in a BWP to which the first sub-signal set belongs in the first time-domain resource simultaneously.

In one embodiment, the first node only transmits a radio signal in the first time-domain resource.

In one embodiment, the first node only transmits a radio signal in the first time-domain resource.

In one embodiment, the first node transmits and receives a radio signal in the first time-domain resource.

In one embodiment, the first node transmits and receives a radio signal in the first time-domain resource in a TDM manner.

In one embodiment, a transmitter of the first signaling receives a radio signal in the second time-domain resource.

In one embodiment, a transmitter of the first signaling only receives a radio signal in the second time-domain resource.

In one embodiment, a transmitter of the first signaling only receives a radio signal in a serving cell to which the first sub-signal set belongs in the second time-domain resource.

In one embodiment, a transmitter of the first signaling only receives a radio signal in a BWP to which the first sub-signal set belongs in the second time-domain resource.

In one embodiment, a transmitter of the first signaling receives and transmits radio signals in the second time-domain resource not simultaneously.

In one embodiment, a transmitter of the first signaling receives and transmits radio signals in a serving cell to which the first sub-signal set belongs in the second time-domain resource not simultaneously.

In one embodiment, a transmitter of the first signaling receives and transmits radio signals in a BWP to which the first sub-signal set belongs in the second time-domain resource not simultaneously.

In one embodiment, the first node transmits a radio signal in the second time-domain resource.

In one embodiment, the first node only transmits a radio signal in the second time-domain resource.

In one embodiment, the first node only transmits a radio signal in a BWP to which the first sub-signal set belongs in the second time-domain resource.

In one embodiment, the first signaling indicates the first time-domain resource.

In one embodiment, the first signaling indicates: a transmitter of the first signaling receives and transmits radio signals in the first time-domain resource simultaneously.

In one embodiment, the first signaling indicates: a transmitter of the first signaling receives and transmits radio signals in the first time-domain resource in a BWP to which the first sub-signal set belongs simultaneously.

In one embodiment, the first signaling indicates that the first node transmits a radio signal in the first time-domain resource.

In one embodiment, the first signaling is used to determine the second time-domain resource.

In one embodiment, the first signaling indicates the second time-domain resource.

In one embodiment, the first signaling and the second signaling are used together to determine the second time-domain resource.

In one embodiment, the first signaling indicates: a transmitter of the first signaling receives a radio signal in the second time-domain resource.

In one embodiment, the first signaling indicates: a transmitter of the first signaling only receives a radio signal in the second time-domain resource.

In one embodiment, the first signaling indicates: a transmitter of the first signaling receives and transmits radio signals simultaneously in the second time-domain resource not.

In one embodiment, the first signaling indicates: a transmitter of the first signaling receives and transmits radio signals not simultaneously in the second time-domain resource in a BWP to which the first sub-signal set belongs.

In one embodiment, the first signaling indicates that the first node transmits a radio signal in the second time-domain resource.

In one embodiment, the first signaling and the second signaling indicate together: a transmitter of the first signaling receives a radio signal in the second time-domain resource.

In one embodiment, the first signaling and the second signaling indicate that the first node transmits a radio signal in the second time-domain resource together.

In one embodiment, the first signaling and the second signaling indicate that the first node only transmits a radio signal in the second time-domain resource together.

In one embodiment, the second signaling comprises a physical-layer signaling.

In one embodiment, the second signaling comprises a layer 1 (L1) signaling.

In one embodiment, the second signaling comprises DCI.

In one embodiment, the second signaling is DCI.

In one embodiment, the second signaling comprises one or more fields of DCI.

In one embodiment, the second signaling comprises a higher-layer signaling.

In one embodiment, the second signaling comprises an RRC signaling.

In one embodiment, the second signaling comprises information in all or partial fields in an IE.

In one subembodiment of the above embodiment, a name of the IE comprises “ConfiguredGrantConfig”.

In one embodiment, any sub-signal in the first sub-signal set comprises a baseband signal.

In one embodiment, any sub-signal in the first sub-signal set comprises a radio signal.

In one embodiment, any sub-signal in the first sub-signal set comprises a radio frequency signal.

In one embodiment, the first bit block comprises bits of a positive integer number greater than 1.

In one embodiment, the first bit block comprises one Transport Block (TB).

In one embodiment, the first bit block comprises one Code Block (CB).

In one embodiment, the first bit block comprises one Code Block Group (CBG).

In one embodiment, any sub-signal in the first sub-signal set is a repetition of the first bit block.

In one embodiment, any sub-signal in the first sub-signal set is an actual repetition of the first bit block.

In one embodiment, the first sub-signal set comprises S sub-signals, where S is a positive integer greater than 1; the S sub-signals are respectively S repetitions of the first bit block.

In one subembodiment of the above embodiment, the S sub-signals are respectively S actual repetitions of the first bit block.

In one embodiment, a number of sub-signals comprised in the first sub-signal set is equal to a number of second-type time windows comprised in the second time window set.

In one embodiment, the first sub-signal set only comprises one sub-signal, and the second time window set only comprises one second-type time window; the sub-signal is transmitted within the second-type time window.

In one embodiment, the sub-signal is transmitted on a PUSCH.

In one embodiment, the first sub-signal set comprises S sub-signals, and the second time window set comprises S second-type time windows, where S is a positive integer greater than 1; the S sub-signals are respectively transmitted in the S second-type time windows.

In one embodiment, the S sub-signals are respectively transmitted on S different PUSCHs.

In one embodiment, the S sub-signals are transmitted on a same PUSCH.

In one embodiment, any sub-signal in the first sub-signal set is transmitted within and only within one second-type time window in the second time window set.

In one embodiment, any two sub-signals in the first sub-signal set are transmitted in two different second-type time windows in the second time window set.

In one embodiment, the second signaling comprises scheduling information for the first sub-signal set; the scheduling information comprises one or more of time-domain resources, frequency-domain resources, a Modulation and Coding Scheme (MCS), a DeModulation Reference Signals (DMRS) port, a Hybrid Automatic Repeat reQuest (HARQ) process number, a Redundancy Version (RV), or a New Data Indicator (NDI).

In one embodiment, all sub-signals in the first sub-signal set occupy same frequency-domain resources.

In one embodiment, there exist two sub-signals in the first sub-signal set occupying different frequency-domain resources.

In one embodiment, all sub-signals in the first sub-signal set adopt a same MCS.

In one embodiment, all sub-signals in the first sub-signal set correspond to a same DMRS port.

In one embodiment, there exist two sub-signals in the first sub-signal set corresponding to different DMRS ports.

In one embodiment, all sub-signals in the first sub-signal set corresponding to a same HARQ process number.

In one embodiment, any two sub-signals in the first sub-signal set correspond to different RVs.

In one embodiment, there exist two sub-signals in the first sub-signal set corresponding to a same RV.

In one embodiment, there exist two sub-signals in the first sub-signal set corresponding to different RVs.

In one embodiment, all sub-signals in the first sub-signal set correspond to a same NDI.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, aradio base station, aradio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

In one embodiment, a radio link between the UE 201 and the gNB 203 is a cellular network link.

In one embodiment, a transmitter of the first signaling comprises the gNB 203.

In one embodiment, a receiver of the first signaling comprises the UE 201.

In one embodiment, a transmitter of the second signaling comprises the gNB 203.

In one embodiment, a receiver of the second signaling comprises the UE 201.

In one embodiment, a transmitter of the first sub-signal set comprises the UE 201.

In one embodiment, a receiver of the first sub-signal set comprises the gNB 203.

In one embodiment, the UE 201 supports more flexible duplex mode or full duplex mode.

### Embodiment 3

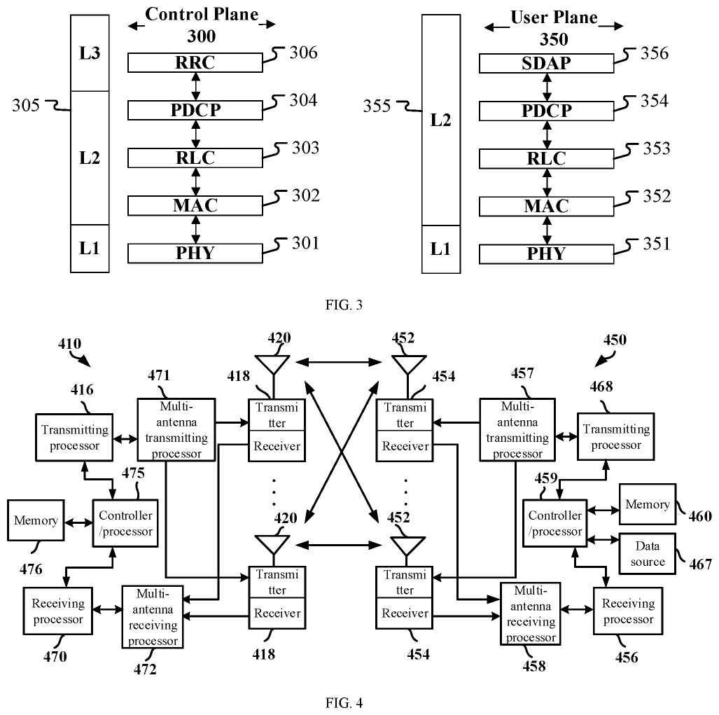

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of aradio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce aradio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling is generated by the RRC sublayer 306.

In one embodiment, the first signaling is generated by the MAC sublayer 302 or the MAC sublayer 352.

In one embodiment, the first signaling is generated by the PHY 301 or the PHY 351.

In one embodiment, the second signaling is generated by the RRC sublayer 306.

In one embodiment, the second signaling is generated by the MAC sublayer 302 or the MAC sublayer 352.

In one embodiment, the second signaling is generated by the PHY 301 or the PHY 351.

In one embodiment, the first sub-signal set is generated by the PHY 301 or the PHY 351.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium, the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives the first signaling; receives the second signaling; transmits the first sub-signal set.

In one embodiment, the second communication device 450 comprises a memory that stores a computer readable instruction program. The computer readable instruction program generates an action when executed by at least one processor. The action includes: receiving the first signaling; receiving the second signaling; transmitting the first sub-signal set.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits the first signaling; transmits the second signaling; receives the first sub-signal set.

In one embodiment, the first communication device 410 comprises a memory that stores a computer readable instruction program. The computer readable instruction program generates an action when executed by at least one processor. The action includes: transmitting the first signaling; transmitting the second signaling; receiving the first sub-signal set.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first signaling; at least one of the antenna 420, the transmitter 418, the transmitting processor 416, the multi-antenna transmitting processor 471, the controller/processor 475, or the memory 476 is used to transmit the first signaling.

In one embodiment, at least one of the antenna 452, the receiver 454, the receiving processor 456, the multi-antenna receiving processor 458, the controller/processor 459, the memory 460, or the data source 467 is used to receive the second signaling; at least one of the antenna 420, the transmitter 418, the transmitting processor 416, the multi-antenna transmitting processor 471, the controller/processor 475, or the memory 476 is used to transmit the second signaling.

In one embodiment, at least one of the antenna 420, the receiver 418, the receiving processor 470, the multi-antenna receiving processor 472, the controller/processor 475 or the memory 476 is used to receive the first sub-signal set; at least one of the antenna 452, the transmitter 454, the transmitting processor 468, the multi-antenna transmitting processor 457, the controller/processor 459, the memory 460, or the data source 467 is used to transmit the first sub-signal set.

### Embodiment 5

Embodiment 5 illustrates a flowchart of wireless transmission according to one embodiment in the present application, as shown in FIG. 5. In FIG. 5, a second node U1 and a first node U2 are communication nodes transmitted via an air interface. In FIG. 5, steps in box F51 are optional.

The second node U1 transmits a first signaling in step S51; transmits a reference signal in P0 reference signal resources in step S5101; transmits a second signaling in step S512; and receives a first sub-signal set in step S513.

The first node U2 receives a first signaling in step S521; receives a reference signal in P0 reference signal resources in step S5201; receives a second signaling in step S522; transmits a first sub-signal set in step S523.

In embodiment 5, the first signaling is used by the first node U2 to determine a first time-domain resource; the second signaling is used by the first node U2 to determine a first time window set; the first time window set comprises at least one first-type time window; the first time window set is used by the first node U2 to determine a second time window set, and the second time window set comprises at least one second-type time window; the first sub-signal set comprises at least one sub-signal, and any sub-signal in the first sub-signal set carries a first bit block; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

In one embodiment, the first node U2 is the first node in the present application.

In one embodiment, the second node U1 is the second node in the present application.

In one embodiment, an air interface between the second node U1 and the first node U2 comprises a radio interface between a base station and a UE.

In one embodiment, an air interface between the second node U1 and the first node U2 comprises a radio interface between a UE and a UE.

In one embodiment, the second node U1 is a serving cell maintenance base station of the first node U2.

In one embodiment, the first time window set is used by the second node U1 to determine the second time window set.

In one embodiment, the first signaling is transmitted on a downlink physical layer data channel (i.e., a downlink channel capable of carrying physical layer data).

In one embodiment, the first signaling is transmitted on a Physical Downlink Shared CHannel (PDSCH).

In one embodiment, the first signaling is transmitted on a downlink physical layer control channel (i.e., a downlink channel only capable of carrying a physical-layer signaling).

In one embodiment, the first signaling is transmitted on a Physical Downlink Control Channel (PDCCH).

In one embodiment, the second signaling is transmitted on a downlink physical layer data channel (i.e., a downlink channel capable of carrying physical layer data).

In one embodiment, the second signaling is transmitted on a PDSCH.

In one embodiment, the second signaling is transmitted on a downlink physical layer control channel (i.e., a downlink channel only capable of bearing a physical-layer signaling).

In one embodiment, the second signaling is transmitted on a PDCCH.

In one embodiment, the first sub-signal set is transmitted on an Uplink physical layer data channel (i.e., an uplink channel capable of carrying physical layer data).

In one embodiment, the first sub-signal set is transmitted on a PUSCH.

In one embodiment, steps in box F51 in FIG. 5 exist; the method in a first node used for wireless communications comprises: receiving a reference signal in P0 reference signal resources; herein, any second-type time window in the second time window set corresponds to one of the P0 reference signal resources, where PG is a positive integer greater than 1.

In one embodiment, steps in box F51 in FIG. 5 exist; the method in a second node for wireless communications comprises: transmitting a reference signal in PG reference signal resources; herein, any second-type time window in the second time window set corresponds to one of the PG reference signal resources, where PG is a positive integer greater than 1.

In one embodiment, there exists one reference signal resource being earlier than the first signaling in the PG reference signals.

In one embodiment, there exists one reference signal resource being later than the first signaling in the PG reference signals.

In one embodiment, there exists one reference signal resource being earlier than the second signaling in the PG reference signals.

In one embodiment, there exists one reference signal resource being later than the second signaling in the P0 reference signals.

### Embodiment 6

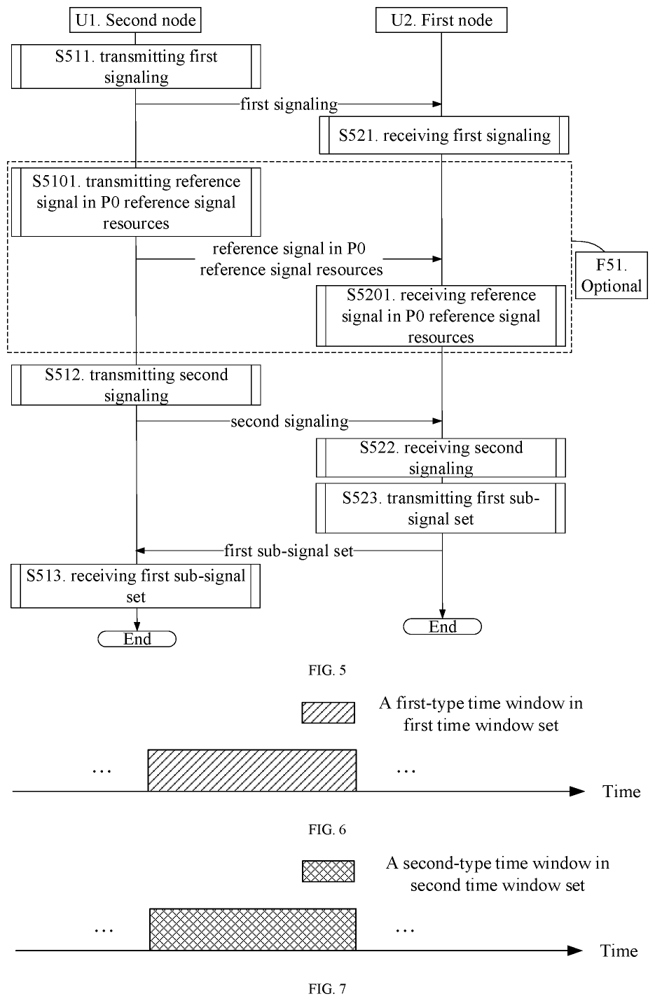

Embodiment 6 illustrates a schematic diagram of a first-type time window according to one embodiment of the present application, as shown in FIG. 6.

In one embodiment, the first time window set only comprises a first-type time window.

In one embodiment, the first time window set comprises multiple first-type time windows.

In one embodiment, any first-type time window in the first time window set is a continuous duration.

In one embodiment, any first-type time window in the first time window set comprises at least one symbol.

In one embodiment, any first-type time window in the first time window set comprises at least one continuous symbol.

In one embodiment, any first-type time window in the first time window set comprises at least one slot.

In one embodiment, any first-type time window in the first time window set comprises at least one sub-slot.

In one embodiment, any two first-type time windows in the first time window set are orthogonal to each other.

In one embodiment, lengths of any two first-type time windows in the first time window set are equal.

In one embodiment, numbers of symbols comprised in any two first-type time windows in the first time window set are equal.

In one embodiment, there exist numbers of symbols comprised in two first-type time windows in the first time window set are not equal.

In one embodiment, any two adjacent first-type time windows in the first time window set are continuous in time domain.

In one embodiment, there exist two adjacent first-type time windows in the first time window set being discontinuous in time domain.

In one embodiment, any first-type time window in the first time window set corresponds a nominal repetition of the first bit block.

In one embodiment, any first-type time window in the first time window set is time-domain resources of a nominal repetition of the first bit block.

In one embodiment, any first-type time window in the first time window set corresponds to a single nominal repetition

In one embodiment, the second signaling indicates a number of first-type time window(s) comprised in the first time window set.

In one embodiment, the second signaling indicates a first SLIV (Start and Length Indicator Value), and the first SLIV indicates a start of a first one of first-type time windows in the first time window set and a length of each first-type time window in the first time window set.

In one embodiment, a first one of symbols in a first one of first-type time windows in the first time window set is a first symbol in a first time unit, and the second signaling indicates a time interval between the first time unit and a time unit to which the second signaling belongs as well as a location of the first symbol in the first time unit.

In one embodiment, an (n+1)-th first-type time window in the first time window set starts from time unit m1, m1 is equal to rounding a value obtained by a second value divided by a first parameter then plus a first value, and a start of a first one of symbols of the (n+1)-th first-type time window relative to the time unit m1 is equal to the second value modulo the first parameter; the second value is equal to a third value plus a product of the n and a fourth value; a value range of n is from 0 to a number of first-type time windows comprised in a first time window set minus 1.

In one embodiment, a (n+1)-th first-type time window in the first time window set ends at time unit m2, m2 is equal to rounding a value obtained by a fifth value divided by a first parameter then plus a first value, and a start of a last one of symbols of the (n+1)-th first-type time window relative to the time unit m2 is equal to the fifth value modulo the first parameter; the fifth value is equal to a third value plus a product of (n+1) and a fourth value then minus 1, and a value range of n is from 0 to a number of first-type time windows comprised in the first time window set minus 1.

In one embodiment, the rounding comprises rounding down.

In one embodiment, the rounding comprises rounding up.

In one embodiment, the first value, the second value, the third value, and the fourth value are respectively non-negative integers, and the first parameter is a number of symbols comprised in a time unit.

In one embodiment, a first one of first-type time windows in the first time window set starts from time unit Ks, and the Ks is equal to the first value.

In one embodiment, the second signaling is used to determine the first value.

In one embodiment, the second signaling indicates a first offset, and the first offset is used to determine the first value.

In one embodiment, the second signaling belongs to time unit p, and the first value is equal to a sum of p and a first offset; the first offset is a non-negative integer, and the second signaling indicates the first offset.

In one embodiment, the third value represents a location of a start symbol of a first one of first-type time windows in the first time window set relative to a start of a time unit to which the start symbol belongs.

In one embodiment, the fourth value represents a number of continuous symbols occupied by any first-type time window in the first time window set.

In one embodiment, the second signaling is used to determine the third value and the fourth value.

In one embodiment, the second signaling indicates a first SLIV, and the first SLIV is used to determine the third value and fourth value.

In one embodiment, the first parameter is equal to 14.

In one embodiment, the first parameter is equal to 12.

In one embodiment, the time unit is a slot.

In one embodiment, the time unit is a sub-slot.

In one embodiment, the time unit is a symbol.

In one embodiment, the time unit consists of more than one positive integer number of continuous symbols.

In one embodiment, a number of symbols comprised in the time unit is configured by an RRC signaling.

### Embodiment 7

Embodiment 7 illustrates a schematic diagram of a second-type time window according to one embodiment of the present application, as shown in FIG. 7.

In one embodiment, the second time window set only comprises a second-type time window.

In one embodiment, the second time window set comprises multiple second-type time windows.

In one embodiment, any second-type time window in the second time window set is a continuous duration.

In one embodiment, any second-type time window in the second time window set comprises at least one symbol.

In one embodiment, any second-type time window in the second time window set comprises at least one continuous symbol.

In one embodiment, any second-type time window in the second time window set comprises at least one slot.

In one embodiment, any second-type time window in the second time window set comprises at least one sub-slot.

In one embodiment, a length of any second-type time window in the second time window set is greater than one symbol.

In one embodiment, there exists a length of a second-type time window in the second time window set equal to one symbol.

In one embodiment, any two second-type time windows in the second time window set are orthogonal to each other.

In one embodiment, there exist numbers of symbols comprised in two second-type time windows in the second time window set being not equal.

In one embodiment, there exist numbers of symbols comprised in two second-type time windows in the second time window set being equal.

In one embodiment, there exist two adjacent second-type time windows in the second time window being continuous in time domain.

In one embodiment, there exist two adjacent second-type time windows in the second time window set being discontinuous in time domain.

In one embodiment, any second-type time window in the second time window set corresponds to an actual repetition of the first bit block.

In one embodiment, any second-type time window in the second time window set is time-domain resources of an actual repetition of the first bit block.

In one embodiment, any second-type time window in the second time window set corresponds to an actual repetition.

In one embodiment, there exists one second-type time window comprising a symbol belonging to the first time-domain resource in the second time window set, and there exists another second-type time window comprising a symbol belonging to the second time-domain resource in the second time window set.

In one embodiment, there exist all symbols in a second-type time window belonging to the first time-domain resource in the second time window set, and there exist all symbols in another second-type time window belonging to the second time-domain resource in the second time window set.

In one embodiment, any symbol in any second-type time window in the second time window set belongs to one of the first time-domain resource or the second time-domain resource.

In one embodiment, all symbols in any second-type time window in the second time window belong to the first time-domain resource or belong to the second time-domain resource.

In one embodiment, there do not exist two symbols respectively belonging to the first time-domain resource and the second time-domain resource in any second-type time window in the second time window set.

In one embodiment, for any given second-type time window in the second time window set, if there exists a symbol belonging to the first time-domain resource in the given second-type time window, there does not exist a symbol belonging to the second time-domain resource in the given second-type time window; if there exists a symbol belonging to the second time-domain resource in the given second-type time window, there does not exist a symbol belonging to the first time-domain resource in the given second-type time window.

In one embodiment, there exists a symbol in the second-type time window set that does not belong to the first time-domain resource or second time-domain resource in the second time window set.

In one embodiment, any second-type time window in the second time window set belongs to a first-type time window in the first time window set.

### Embodiment 8

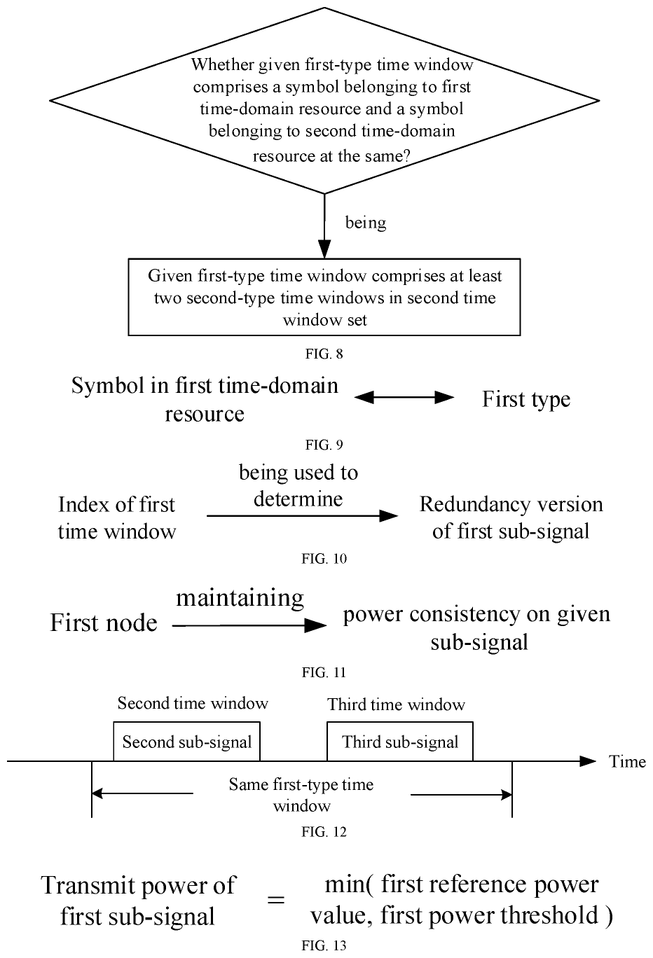

Embodiment 8 illustrates a schematic diagram of a given first-type time window comprising a second-type time window according to one embodiment of the present application, as shown in FIG. 8. In embodiment 8, when the given first-type time window comprises both symbols belonging to the first time-domain resource and symbols belonging to the second time-domain resource, the given first-type time window comprises at least two second-type time windows in the second time window set.

In one embodiment, the given first-type time window is any first-type time window in the first time window set.

In one embodiment, the given first-type time window is any first-type time window whose remaining number of symbols is greater than a first threshold after excluding symbols belonging to an invalid symbol set; the first threshold is a non-negative integer.

In one subembodiment of the above embodiment, the first threshold is equal to 0.

In one subembodiment of the above embodiment, the first threshold is equal to 1.

In one embodiment, the invalid symbol set is configured by a higher-layer signaling.

In one embodiment, the invalid symbol set is configured by an RRC signaling.

In one embodiment, the invalid symbol set comprises a symbol configured as downlink by a first IE; a name of the first IE comprises “tdd-UL-DL-Config”.

In one embodiment, the invalid symbol set comprises a symbol used for SS (Synchronization Signal)/PBCH (Physical Broadcast Channel) block reception.

In one embodiment, the invalid symbol set comprises a symbol used for a CORESET (COntrol REsource SET) set of TypeO-PDCCH CSS (Common Search Space).

In one embodiment, the invalid symbol set comprises a first reference value number of symbol(s) after a last symbol in each continuous symbol set in all symbols indicated by a first IE as downlink, and the first reference value is indicated by a first higher-layer parameter; a name of the first higher-layer parameter comprises “numberOflnvalidSymbolsForDL-UL-Switching”, and a name of the first IE comprises “tdd-UL-DL-Config”.

In one embodiment, the invalid symbol set comprises symbols indicated by a second higher-layer parameter, and a name of the second higher-layer parameter comprises “invalidSymbolPattern”.

In one embodiment, whether the given first-type time window comprises symbols belonging to the first time-domain resource and symbols belonging to the second time-domain resource simultaneously is used by the first node to determine that the given first-type time window comprises several second-type time windows in the second-type time window set.

In one embodiment, when the given first-type time window comprises symbols belonging to only one of the first time-domain resource and second time-domain resource, the given first-type time window comprises several second-type time windows in the second-type time window set is related to and whether the given first-type time window comprises symbols belonging to different time units and whether the given first-type time window comprises symbols belonging to the invalid symbol set.

In one embodiment, a remaining symbol set consists of all symbols remaining after excluding symbols belonging to the radio symbol set in the given first-type time window; the given first-type time window comprising several second-type time windows is related to whether the remaining symbol set comprises both symbols belonging to the first time-domain resource and symbols belonging to the second time-domain resource.

In one embodiment, the remaining symbol set is used to determine one or more second-type time windows comprised in the given first-type time window.

In one embodiment, whether the remaining symbol set comprises both symbols belonging to the first time-domain resource and symbols belonging to the second time-domain resource is used to determine how many second time windows the given first-type time window comprises.

In one embodiment, when the remaining symbol set comprises both symbols belonging to the first time-domain resource and symbols belonging to the second time-domain resource, the given first-type time window comprises at least two second-type time windows in the second time window set.

In one embodiment, when the remaining symbol set comprises symbols belonging to only one of the first time-domain resource and the second time-domain resource, the given first-type time window comprising several second-type time windows is related to whether the remaining symbol set comprises symbols belonging to different time units and whether the remaining symbol set comprises discontinuous symbols.

In one embodiment, whether the remaining symbol set satisfies a first condition is used to determine how many second-type time windows the given first-type time window comprises; when the remaining symbol set satisfies the first condition, the given first-type time window comprises only one second-type time window in the second-type time window set, and the only second-type time window consists of all symbols in the remaining symbol set; when the remaining symbol set does not meet the first condition, the given first-type time window comprises at least two second-type time windows in the second-type time window set, and the remaining symbol set is used to generate the at least two second-type time windows.

In one embodiment, the first condition comprises: all symbols comprised are continuous in time domain.

In one embodiment, the first condition comprises: all symbols comprised belong to a same time unit.

In one embodiment, the first condition comprises: all symbols comprised belong to a same slot.

In one embodiment, the first condition comprises: comprising symbols belonging to only one time-domain resource in the first time-domain resource and the second time-domain resource.

In one embodiment, the first condition comprises: all symbols comprised belong to the first time-domain resource or belong to the second time-domain resource.

In one embodiment, the first condition comprises: all comprised symbols being continuous in time domain, all comprised symbols belonging to a same slot, and comprising symbols belonging to only one time-domain resource in the first time-domain resource and the second time-domain resource.

In one embodiment, the meaning of the phrase of comprising symbols in only one time-domain resource in the first time-domain resource and the second time-domain resource comprises: if a symbol belonging to the first time-domain resource is comprised, then a symbol belonging to the second time-domain resource is not comprised; if a symbol belonging to the second time-domain resource is comprised, then a symbol belonging to the first time-domain resource is not comprised.

In one embodiment, any second-type time window in the second time window set satisfies the first condition.

In one embodiment, any second-type time window in the second time window set satisfies the first condition and a number of comprised symbols is greater than 1.

In one embodiment, the remaining symbol set comprises K symbol subsets, K being a positive integer greater than 1; any symbol subset in the K symbol subsets satisfies the first condition; the given first-type time window comprises K second-type time windows in the second-type time window set, and the K second-type time windows respectively consist of K symbol subsets.

In one subembodiment of the above embodiment, any symbol subset in the K symbol subsets satisfies the first condition and a number of comprised symbols is greater than 1.

In one subembodiment of the above embodiment, any symbol subset in the K symbol subsets comprises all symbols satisfying the first condition in the remaining symbol set.

In one subembodiment of the above embodiment, a given symbol is any symbol in the remaining symbol set, and a reference symbol subset is a symbol subset in the K symbol subsets; if the given symbol and a symbol in the reference symbol set belong to a same time unit, being continuous in time domain, and do not belong to the first time-domain resource and second time-domain resource respectively, the given symbol belongs to the reference symbol subset.

In one subembodiment of the above embodiment, a given symbol is any symbol in the remaining symbol set, and a reference symbol subset is a symbol subset in the K symbol subsets; if the given symbol and a symbol in the reference symbol set belong to a same time unit, being continuous in time domain, and all belong to the first time-domain resource or belong to the second time-domain resource, and the given symbol belongs to the reference symbol subset.

In one embodiment, a number of symbols comprised in any of the K second-type time windows is greater than 1.

In one embodiment, any symbol in the remaining symbol set belongs to one of the K symbol subsets.

In one embodiment, there exists one symbol in the remaining symbol set not belonging to the K symbol subsets.

### Embodiment 9

Embodiment 9 illustrates a schematic diagram of a first signaling configuring a symbol in a first time-domain resource as a first type according to one embodiment of the present application, as shown in FIG. 9.

In one embodiment, the first type is different from uplink and downlink.

In one embodiment, the first type is different from uplink, downlink and flexible.

In one embodiment, if a type of a symbol is the first type, a transmitter of the first signaling simultaneously receives and transmits radio signals on the same symbol.

In one embodiment, if a symbol is not configured as the first type, a transmitter of the first signaling only receives a radio signal or only transmits a radio signal on the symbol.

In one embodiment, if a type of a symbol is the first type, the first node only receives a radio signal or only transmits a radio signal on the symbol.

In one embodiment, the first type is a type in a first type set, any symbol is configured as a type in the first type set, and a type of the first type set comprises the first type, uplink and downlink.

In one subembodiment of the above embodiment, types in the first type set comprise flexible.

In one embodiment, the meaning of the phrase of “configuring a symbol in the first time-domain resource as a first type” comprises: configuring each symbol in the first time-domain resource as the first type.

In one embodiment, the meaning of the phrase of “configuring a symbol in the first time-domain resource as a first type” comprises: configuring at least one symbol in the first time-domain resource as the first type.

In one embodiment, the meaning of the phrase of “configuring a symbol in the first time-domain resource as a first type” comprises: indicating a type of a symbol in the first time-domain resource as the first type.

In one embodiment, the meaning of the phrase that the first signaling is used to determine a first time-domain resource comprises: the first signaling configures a symbol in the first time-domain resource as the first type.

In one embodiment, the meaning of the phrase that the first signaling is used to determine a first time-domain resource comprises: the first signaling indicates that a type of a symbol in the first time-domain resource as the first type.

In one embodiment, the first time-domain resource belongs to a first time-domain resource pool, and the first signaling indicates the first time-domain resource from the first time-domain resource pool; the first time window set belongs to the first time-domain resource pool.

In one embodiment, the first signaling indicates the first time-domain resource from the first time-domain resource pool, and configures a symbol in the first time-domain resource as the first type.

In one embodiment, the first signaling indicates that a type of a symbol in only the first time-domain resource in the first time-domain resource pool is the first type.

In one embodiment, the first time-domain resource pool comprises multiple continuous symbols.

In one embodiment, the first time-domain resource pool comprises at least one slot.

In one embodiment, the first time-domain resource pool comprises at least one subframe.

In one embodiment, at least one symbol in the first time-domain resource pool does not belong to the first time-domain resource and the second time-domain resource.

In one embodiment, the first signaling configures symbols in the first time-domain resource as the first type in a serving cell to which the first sub-signal set belongs.

In one embodiment, the first signaling configures symbols in the first time-domain resource as the first type in a BWP to which the first sub-signal set belongs.

In one embodiment, symbols in the second time-domain resource are configured as a second type.

In one embodiment, a type of symbols in the second time-domain resource is a second type.

In one embodiment, the first signaling configures a symbol in the second time-domain resource as a second type.

In one embodiment, the second type comprises uplink.

In one embodiment, the second type is uplink.

In one embodiment, if a type of a symbol is of the second type, a transmitter of the first signaling only receives a radio signal on the symbol.

In one embodiment, if a type of a symbol is the second type, a transmitter of the first signaling does not simultaneously receive and transmit a radio signal on the same symbol.

In one embodiment, if a type of a symbol is the second type, the first node only transmits a radio signal on the symbol.

In one embodiment, the first signaling configures any symbol in the second time-domain resource as second type or third type.

In one embodiment, the first signaling configures any symbol in a third time-domain resource as second type or third type, and the second signaling is used to determine the first time window set; an intersection of the third time-domain resource and the first time window set is used to determine the second time-domain resource.

In one subembodiment of the above embodiment, the second time-domain resource consists of an intersection of the third time-domain resource and the first time window set.

In one embodiment, the third type comprises flexible.

In one embodiment, the third type is flexible.

In one embodiment, the second time-domain resource belongs to the first time-domain resource pool; the first signaling indicates that a type of a symbol in only the second time-domain resource in the first time-domain resource pool is of the second type.

In one embodiment, the second time-domain resource belongs to the first time-domain resource pool; the first signaling indicates that a type of a symbol in only the second time-domain resource in the first time-domain resource pool is of the second type or the third type.

In one embodiment, the third time-domain resource belongs to the first time-domain resource pool; the first signaling indicates that a type of a symbol in only the third time-domain resource in the first time-domain resource pool is of the second type or the third type.

In one embodiment, a type of any symbol in any second-type time window in the second time window set is either the first type or the second type.

In one embodiment, there exists a type of a symbol in a second-type time window in the second time window set being a third type.

### Embodiment 10

Embodiment 10 illustrates a schematic diagram of an RV of a first sub-signal being related to an index of a first time window according to one embodiment of the present application, as shown in FIG. 10. In embodiment 10, an index of the first time window is used to determine the RV of the first sub-signal.

In one embodiment, the RV refers to the redundancy version.

In one embodiment, the RV of the first sub-signal is a non-negative integer.

In one embodiment, the RV of the first sub-signal is a non-negative integer not less than 4.

In one embodiment, the second signaling indicates a first RV, and the first RV is a (x1+1)-th RV in a first RV set; the index of the first time window is equal to a first index; the RV of the first sub-signal is equal to a (x2+1)-th RV in the first RV set, and the x2 is equal to the first index modulo 4, plus the x1 and then modulo 4; the first RV set is {0, 2, 3, 1}; a value range for x1 and x2 is 0˜3 respectively.

In one embodiment, the second signaling indicates a first RV, and the first RV is a (x1+1)-th RV in a first RV set; the index of the first time window is equal to a first index; the RV of the first sub-signal is equal to a sum of a (x2+1)-th RV in the first RV set and a second offset then modulo 4; the x2 is equal to the first index modulo 4, plus the x1 and then modulo 4; the first RV set is {0, 2, 3, 1}; the second offset is a non-negative integer less than 4; a value range for x1 and x2 is 0˜3 respectively.

In one subembodiment of the above embodiment, the second offset is configured by a higher-layer signaling.

In one subembodiment of the above embodiment, the second offset is configured by a physical-layer signaling.

In one embodiment, the index of the first time window refers to: an index of the first time window in the second time window set.

In one subembodiment of the above embodiment, a value range of the index of the first time window is 0˜a number of second-type time window(s) comprised in the second time window set minus 1.

In one embodiment, the first time window is an (x+1)-th second-type time window in the second time window set, and the index of the first time window is equal to x.

In one embodiment, the index of the first time window refers to: an index of the first time window in a second time window subset, and the second time window subset is a subset of the second time window set.

In one subembodiment of the above embodiment, a value range of the index of the first time window is 0˜a number of second-type time window(s) comprised in the second time window subset minus 1.

In one embodiment, the first time window is an (x+1)-th second-type time window in the second time window subset, and the index of the first time window is equal to x.

In one embodiment, second-type time windows in the second time window set are sequentially indexed in an ascending order in time domain.

In one embodiment, second-type time windows in the second time window subset are sequentially indexed in an ascending order in time domain.

In one embodiment, first-type time windows in the first time window set are sequentially indexed in an ascending order in time domain.

In one embodiment, the second time window subset is the second time window set.

In one embodiment, the second time window subset is a true subset of the second time window set.

In one embodiment, the second time window subset comprises at least one second-type time window, and any second-type time window in the second time window subset belongs to the second time window set.

In one embodiment, there exists one second-type time window in the second time window set not belonging to the second time window subset.

In one embodiment, any second-type time window in the second time window set corresponds to one of P0 reference signal resources, where P0 is a positive integer greater than 1; the first time window corresponds to a first reference signal resource among the PG reference signal resources.

In one embodiment, any second-type time window in the second time window set corresponds to one of PG reference signal resources, where PG is a positive integer greater than 1; the second time window subset consists of all second-type time windows corresponding to a first reference signal resource in the second time window set, and the first reference signal resource is a reference signal resource corresponding to the first time window in the PG reference signal resources.

In one embodiment, any second-type time window in the second time window set corresponds to only one of the PG reference signal resources.

In one embodiment, there exist two second-type time windows in the second time window set respectively corresponding to different reference signal resources in the PG reference signal resources.

In one embodiment, the PG is equal to 2.

In one embodiment, the PG is greater than 2.

In one embodiment, any of the PG reference signal resources comprises one of the CSI-RS (Channel State Information Reference Signal) resources, SS/PBCH block resources, or SRS (Sounding Reference Signal) resources.

In one embodiment, the second signaling indicates the PG reference signal resources.

In one embodiment, the second signaling indicates PG TCIs (Transmission Configuration Indicators), and the PG TCIs respectively indicate the PG reference signal resources.

In one embodiment, the second signaling indicates a TCI field codepoint corresponding to the PG TCIs.

In one embodiment, the second signaling indicates the PG reference signal resources in order.

In one embodiment, the second signaling indicates the PG TCIs in order.

In one embodiment, the second signaling indicates a first TCI codepoint, and the first TCI codepoint sequentially indicates the PG TCIs.

In one embodiment, a DMRS of a sub-signal transmitted in any second-type time window in the second time window set in the first sub-signal set and a reference signal transmitted in reference signal resources corresponding to the any second-type time window are quasi co-located.

In one embodiment, a DMRS of a sub-signal transmitted in any second-type time window in the second time window set in the first sub-signal set and a reference signal transmitted in reference signal resources corresponding to the any second-type time window are quasi co-located and corresponding to QCL-TypeD.

In one embodiment, a DMRS of the first sub-signal and a reference signal transmitted in the first reference signal resource are quasi co-located.

In one embodiment, a DMRS of the first sub-signal and a reference signal transmitted in the first reference signal resource are quasi co-located and corresponding to QCL-TypeD.

In one embodiment, an index of the first-type time window to which the first time window belongs in the first time window set is used to determine the first reference signal resource.

In one embodiment, a first-type time window to which the first time window belongs is an (x0+1)-th first-type time window in the first time window set, and the x0 is used to determine the first reference signal resource; a value range of x0 is 0˜ a number of first-type time windows comprised in the first time window set minus 1.

In one embodiment, the first time window belongs is an (x0+1)-th second-type time window in the second time window set, and the x0 is used to determine the first reference signal resource; a value range of x0 is 0˜ a number of second-type time windows comprised in the second time window set minus 1.

In one embodiment, the first time window corresponds to a (y+1)-th reference signal resource among the P0 reference signal resources; y is equal to the x0 modulo P0.

In one embodiment, the first time window corresponds to a (y+1)-th reference signal resource among the PG reference signal resources; y is equal to a second parameter modulo P0, and the second parameter is equal to x0 divided by 2 and then rounded down to an integer.

In one embodiment, the second signaling indicates P1 reference signal resource(s) in the PG reference signal resources; P1 is a positive integer less than PG.

In one embodiment, the second signaling indicates P1 TCIs, and the P1 TCIs respectively indicate P1 reference signal resources.

In one embodiment, the second signaling indicates a TCI field codepoint corresponding to the P1 TCIs.

In one embodiment, the second signaling indicates the P1 reference signal resources in order.

In one embodiment, the second signaling indicates the P1 TCIs in order.

In one embodiment, the second signaling indicates a second TCI codepoint, and the second TCI codepoint indicates P1 TCIs in order.

In one embodiment, P1 is equal to the P minus 1.

In one embodiment, reference signal resources not belonging to the P1 reference signal resources among the P0 reference signal resources are configured by a third signaling.

In one subembodiment of the above embodiment, the third signaling is an RRC signaling.

In one subembodiment of the above embodiment, the third signaling is a MAC CE signaling.

In one subembodiment of the above embodiment, the third signaling is a physical-layer signaling.

In one subembodiment of the above embodiment, the third signaling and the second signaling are transmitted on different physical-layer channels.

In one subembodiment of the above embodiment, the third signaling and the second signaling are carried by different IEs.

In one embodiment, the first time window comprising a symbol belonging to the first time-domain resource or a symbol belonging to the second time-domain resource is used to determine the first reference signal.

In one embodiment, when the first time window comprises symbols belonging to the first time-domain resource, the first reference signal is a reference signal resource not belonging to the P1 reference signal resource among the P0 reference signal resources.

In one embodiment, when the first time window comprises symbols belonging to the second time-domain resource, the first reference signal is one of the P1 reference signal resources.

In one subembodiment of the above embodiment, the first time window corresponds to a (y+1)-th reference signal resource among the P1 reference signal resources; y is equal to the x0 modulo P1.

In one subembodiment of the above embodiment, the first time window corresponds to a (y+1)-th reference signal resource among the P1 reference signal resources; y is equal to a second parameter modulo P1, and the second parameter is equal to x0 divided by 2 and then rounded down to an integer.

In one embodiment, the RV of the first sub-signal is unrelated to a location of a first-type time window to which the first time window belongs in the first time window subset, and the first time window subset is a subset of the first time window set.

In one embodiment, the first time window subset is the first time window set.

In one embodiment, the first time window subset is a true subset of the first time window set.

In one embodiment, the first time window subset comprises at least one first-type time window, and any first-type time window in the first time window subset belongs to the first time window set.

In one embodiment, any first-type time window in the first time window set corresponds to one of PG reference signal resources, where P0 is a positive integer greater than 1; a first-type time window to which the first time window belongs corresponds to a first reference signal resource among the P0 reference signal resources, and the first time window subset consists of all first-type time windows corresponding to the first reference signal resource in the first time window set.

### Embodiment 11

Embodiment 11 illustrates a schematic diagram of a first node maintaining consistent power to a given sub-signal according to one embodiment of the present application, as shown in FIG. 11.

In one embodiment, the meaning of the phrase that the first node maintains consistent power to the given signal comprises: the first node transmits any part of the given sub-signal with same transmit power.

In one embodiment, the meaning of the phrase that the first node maintains consistent power to the given signal comprises: the first node maintains power consistency between any different parts of the given sub-signal.

In one embodiment, the meaning of the phrase of maintaining power consistency comprises: maintaining consistent power on each RB (Resource Block).

In one embodiment, the meaning of the phrase of maintaining power consistency comprises: maintaining same power per RB on each symbol.

In one embodiment, the first node calculates transmit power respectively for different sub-signals in the first sub-signal set.

In one subembodiment of the above embodiment, the behavior of calculating transmit power is carried out according to the method in Chapter 7 of 3GPP TS38.312.

In one embodiment, a target receiver of the first sub-signal set expects that the first node maintains power consistency on the given sub-signal.

In one embodiment, a target receiver of the first sub-signal set assumes that the first node maintains power consistency on the given sub-signal, and receives the first sub-signal set based on the assumption.

In one embodiment, the first node does not maintain power consistency between different sub-signals in the first sub-signal set.

In one embodiment, the first node determines on its own whether to maintain power consistency between different sub-signals in the first sub-signal set.

In one embodiment, a target receiver of the first sub-signal set does not expect the first node to maintain power consistency between different sub-signals in the first sub-signal set.

In one embodiment, a target receiver of the first sub-signal set assumes that the first node does not maintain power consistency between different sub-signals in the first sub-signal set, and receives the first sub-signal set based on this assumption.

In one embodiment, the second time window set comprises at least one third-type time window; whether the first node maintains power consistency between two different sub-signals in the first sub-signal set and whether the two different sub-signals belong to a same third-type time window; when the two different sub-signals belong to a same third-type time window, the first node maintains power consistency between the two different sub-signals; when the two different sub-signals do not belong to a same third-type time window, the first node does not maintain power consistency between the two different sub-signals; a length of the third-type time window shall not exceed a second threshold.

In one embodiment, the second threshold is a positive integer.

In one embodiment, the second threshold is a positive real number.

In one embodiment, the second threshold is configurable.

In one embodiment, the second threshold is configured by higher-layer parameters.

In one embodiment, the second threshold is reported by the first node to a transmitter of the first signaling.

In one embodiment, the second threshold is indicated to the first node by a transmitter of the first signaling.

In one embodiment, the second threshold is measured by millisecond (ms).

In one embodiment, the second threshold is measured by symbol.

In one embodiment, a start of any third-type time window in the at least one third-type time window is a start of a second-type time window in the second-type time window set.

In one embodiment, any third-type time window in the at least one third-type time window comprises one or more second-type time windows in the second-type time window set.

In one embodiment, a given third-type time window is any third-type time window comprising multiple second-type time windows in the at least one third-type time window, and the multiple second-type time windows correspond to a same reference signal resource among the P0 reference signal resources.

In one embodiment, the first node maintains phase continuity to the given sub-signal.

In one embodiment, the first node maintains phase continuity between different parts of the given sub-signal.

In one embodiment, a target receiver of the first sub-signal set assumes that the first node maintains phase continuity to the given sub-signal, and receives the first sub-signal set based on the assumption.

In one embodiment, the first node does not maintain phase continuity between different sub-signals in the first sub-signal set.

In one embodiment, the first node determines on its own whether to maintain phase continuity between different sub-signals in the first sub-signal set.

In one embodiment, a target receiver of the first sub-signal set assumes that the first node does not maintain phase continuity between different sub-signals in the first sub-signal set.

In one embodiment, the meaning of the phrase of maintaining phase continuity comprises: maintaining phase continuity between DMRSs.

In one embodiment, the meaning of the phrase of maintaining phase continuity comprises: maintaining no phase transition.

In one embodiment, the meaning of the phrase of maintaining phase continuity comprises: maintaining phase continuity of the phase-locked loop.

In one embodiment, the meaning of the phrase of maintaining phase continuity comprises: maintaining the phase of the phase-locked loop unchanged.

### Embodiment 12

Embodiment 12 illustrates a schematic diagram of a second time window, a third time window, a second sub-signal and a third sub-signal according to one embodiment of the present application, as shown in FIG. 12. In embodiment 12, a second time window and a third time window are respectively two second-type time windows in the second time window set, and the second time window and the third time window belong to a same first-type time window in the first time window set; the second sub-signal and the third sub-signal are respectively sub-signals transmitted in the second time window and third time window in the first sub-signal set; the second sub-signal and the third sub-signal are not quasi co-located.

In one embodiment, the second time window and the third time window are any two second-type time windows in the second time window set belonging to a same first-type time window in the first time window set.

In one embodiment, a fourth time window and a fifth time window are respectively two second-type time windows in the second time window set, and the fourth time window and the fifth time window belong to a same first-type time window in the first time window set; two sub-signals respectively transmitted in the fourth time window and the fifth time window in the first sub-signal set are quasi co-located.

In one subembodiment of the above embodiment, the two sub-signals are quasi co-located and corresponding to QCL-TypeD.

In one subembodiment of the above embodiment, any of the fourth time window and fifth time window is orthogonal to any of the second time window and third time window in time domain.

In one embodiment, the second time window and the third time window are any two second-type time windows in the second time window set belonging to a same first-type time window in the first time window set, and respectively comprising symbols belonging to the first time-domain resource and symbols belonging to the second time-domain resource.

In one embodiment, when and only when the second time window comprises symbols belonging to the first time-domain resource and the third time window comprises symbols belonging to the second time-domain resource, the second sub-signal and third sub-signal are not quasi co-located.

In one subembodiment of the above embodiment, the second sub-signal and the third sub-signal are not quasi co-located and corresponding to QCL-TypeD.

In one embodiment, the quasi co-located refer to: quasi co-located_{•}

In one embodiment, the second sub-signal and the third sub-signal are not quasi co-located corresponding to QCL TypeD.

In one embodiment, a DMRS of the second sub-signal and a DMRS of the third sub-signal are not quasi co-located.

In one embodiment, a DMRS of the second sub-signal and a DMRS of the third sub-signal are not quasi co-located corresponding to QCL TypeD.

### Embodiment 13

Embodiment 13 illustrates a schematic diagram of transmit power of a first sub-signal according to one embodiment of the present application, as shown in FIG. 13. In embodiment 13, the transmit power of the first sub-signal is equal to a minimum value between a first reference power value and a first power threshold.

In one embodiment, the transmit power of the first sub-signal is measured by dBm.

In one embodiment, the first reference power value is measured by dBm.

In one embodiment, the first power threshold is measured by dBm.

In one embodiment, the transmit power of the first sub-signal is calculated according to the method in one of the chapters 7.1, 7.2, 7.3, or 7.4 of 3GPP TS38.213.

In one embodiment, the first power threshold is P_{CMAX,f,c}(i), the P_{CMAX,f,c}(i) is maximum output power of transmission occasion i on carrier f of serving cell c, and the first sub-signal is transmitted in transmission occasion i on carrier f of serving cell c.

In one embodiment, the first reference power value is linearly correlated with a sum of R1 offsets, R1 being a positive integer; a linear coefficient between the first reference power value and a sum of the R1 offsets is 1; any of the R1 offsets is indicated by Transmitter Power Control (TPC).

In one subembodiment of the above embodiment, a sum of the R1 offsets is power control adjustment state.

In one embodiment, the first reference power value is linearly related to a first component, and a linear coefficient between the first reference power value and the first component is 1.

In one subembodiment of the above embodiment, the first component is target power.

In one subembodiment of the above embodiment, the first component is P₀.

In one embodiment, the first reference power value is linearly correlated with a second component, the second component is related to a bandwidth in resource block to which the first sub-signal is allocated, and a linear coefficient between the first reference power value and the second component is 1.

In one embodiment, the first reference power value is linearly correlated with a first pathloss, and a linear coefficient between the first reference power value and the first pathloss is a non-negative real number less than or equal to 1.

In one subembodiment of the above embodiment, the first pathloss is measured by dB.

In one embodiment, the first reference power value is linearly related to a third component, the third component is related to an MCS of the first sub-signal, and a linear coefficient between the first reference power value and the third component is 1.

In one embodiment, the first reference power value is respectively and linearly correlated to the first component, the second component, the third component, a sum of the R1 offsets and the first pathloss; a linear coefficient between the first reference power value and the first component, the second component, the third component as well as a sum of the R1 offsets is 1, and a linear coefficient between the first reference power value and the first pathloss is a non-negative real number not greater than 1.

In one embodiment, the first reference power value is respectively linearly correlated with the first component, the second component, a sum of the R1 offsets as well as the first pathloss; a linear coefficient between the first reference power value and the first component, the second component as well as a sum of the R1 offsets is 1, and a linear coefficient between the first reference power value and the first pathloss is a non-negative real number not greater than 1.

### Embodiment 14

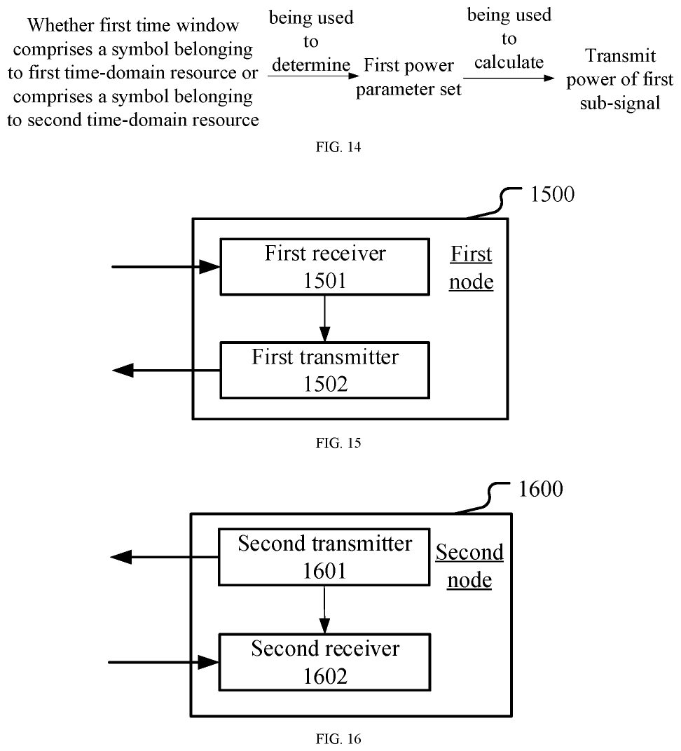

Embodiment 14 illustrates a schematic diagram of a first power parameter set being related to whether a first time window comprises symbols belonging to a first time-domain resource or symbols belonging to the second time-domain resource according to an embodiment of the present application, as shown in FIG. 14. In embodiment 14, whether the first time window comprises a symbol belonging to the first time-domain resource or a symbol belonging to the second time-domain resource is used by the first node to determine the first power parameter set; a first power parameter set is used by the first node to calculate transmit power of the first sub-signal.

In one embodiment, the first power parameter set comprises the first component.

In one embodiment, the first power parameter set only comprises the first component.

In one embodiment, the first power parameter set comprises the first power threshold.

In one embodiment, the first power parameter set only comprises the first power threshold.

In one embodiment, the first power parameter set comprises the first component and the first power threshold.

In one embodiment, the first power parameter set comprises a linear coefficient between the first reference power value and the first pathloss.

In one embodiment, the first power parameter set is one of a first candidate power parameter set or a second candidate power parameter set; when the first time window comprises symbols belonging to the first time-domain resource, the first power parameter set is the first candidate power parameter set; when the first time window comprises symbols belonging to the second time-domain resource, the first power parameter set is the second candidate power parameter set.

In one embodiment, the first power parameter set is one of a first candidate power parameter set or a second candidate power parameter set; when there exists a type of a symbol in the first time window being the first type, the first power parameter set is the first candidate power parameter set; when there exists a type of a symbol in the first time window being the second type, the first power parameter set is the second candidate power parameter set.

In one embodiment, the first candidate power parameter set and the second candidate power parameter set are respectively configurable.

In one embodiment, a value of at least one power parameter in the first candidate power parameter set is not equal to a value of a power parameter corresponding to the second candidate power parameter set.

In one embodiment, the first power parameter set comprises the first component; when the first time window comprises symbols belonging to the first time-domain resource, a value of the first component is greater than a value of the first component when the first time window comprises symbols belonging to the second time-domain resource.

In one embodiment, the first power parameter set comprises the first component; when the first time window comprises symbols belonging to the first time-domain resource, a value of the first component is less than a value of the first component when the first time window comprises symbols belonging to the second time-domain resource.

### Embodiment 15

Embodiment 15 illustrates a structure block diagram of a processor in a first node according to one embodiment of the present application, as shown in FIG. 15. In FIG. 15, a processor 1500 in a first node comprises a first receiver 1501 and a first transmitter 1502.

In Embodiment 15, the first receiver 1501 receives a first signaling and a second signaling; the first transmitter 1702 transmits a first sub-signal set.

In embodiment 15, the first signaling is used to determine a first time-domain resource, and the second signaling is used to determine a first time window set; the first sub-signal set comprises at least one sub-signal, and any sub-signal in the first sub-signal set carries a first bit block; the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

In one embodiment, the first signaling configures a symbol in the first time-domain resource as a first type.

In one embodiment, a first sub-signal is a sub-signal transmitted in a first time window in the first sub-signal set, and the first time window is any second-type time window in the second time window set; a redundancy version (RV) of the first sub-signal is related to an index of the first time window.

In one embodiment, a given sub-signal is any sub-signal in the first sub-signal set, and the first node maintains power consistency on the given sub-signal.

In one embodiment, a second time window and a third time window are respectively two second-type time windows in the second time window set, and the second time window and the third time window belong to a same first-type time window in the first time window set; a second sub-signal and a third sub-signal are respectively sub-signals transmitted in the second time window and the third time window in the first sub-signal set; the second sub-signal and the third sub-signal are not quasi co-located.

In one embodiment, a first sub-signal is a sub-signal transmitted in a first time window in the first sub-signal set, and the first time window is any second-type time window in the second time window set; a first power parameter set is used to calculate transmit power of the first sub-signal; the first power parameter set is related to whether the first time window comprises a symbol belonging to the first time-domain resource or a symbol belonging to the second time-domain resource.

In one embodiment, the first receiver receives a reference signal in P0 reference signal resources; any second-type time window in the second time window set corresponds to one of the P0 reference signal resources, where PG is a positive integer greater than 1.

In one embodiment, a transmitter of the first signaling receives and transmits radio signals in the first time-domain resource simultaneously; a transmitter of the first signaling receives a radio signal in the second time-domain resource; a transmitter of the first signaling receives and transmits radio signals in the second time-domain resource not simultaneously; the given first-type time window is any first-type time window whose remaining number of symbols is greater than a first threshold after excluding symbols belonging to an invalid symbol set in the first time window set; the first threshold is a non-negative integer; any second-type time window in the second time window set satisfies a first condition; the first condition comprises: all comprised symbols being continuous in time domain, all comprised symbols belonging to a same slot, and comprising symbols belonging to only one time-domain resource in the first time-domain resource and the second time-domain resource.

In one embodiment, the given first-type time window is any first-type time window whose remaining number of symbols is greater than a first threshold after excluding symbols belonging to an invalid symbol set in the first time window set; the first threshold is a non-negative integer; any second-type time window in the second time window set satisfies a first condition; the first condition comprises: all comprised symbols being continuous in time domain, all comprised symbols belonging to a same slot, and comprising symbols belonging to only one time-domain resource in the first time-domain resource and the second time-domain resource.

In one embodiment, the first node is a UE.

In one embodiment, the first node is a relay node.

In one embodiment, the first receiver 1501 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 1502 comprises at least one of the antenna 452, the transmitter 454, the transmitting processor 468, the multi-antenna transmitting processor 457, the controller/processor 459, the memory 460, or the data source 467 in Embodiment 4.

### Embodiment 16

Embodiment 16 illustrates a structure block diagram of a processor in a second node according to one embodiment of the present application, as shown in FIG. 16. In FIG. 16, a processor 1600 in a second node comprises a second transmitter 1601 and a second receiver 1602.

In Embodiment 16, the second transmitter 1601 transmits a first signaling and a second signaling; the second receiver 1602 receives a first sub-signal set.

In embodiment 16, the first signaling is used to determine a first time-domain resource, and the second signaling is used to determine a first time window set; the first sub-signal set comprises at least one sub-signal, and any sub-signal in the first sub-signal set carries a first bit block; the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

In one embodiment, the first signaling configures a symbol in the first time-domain resource as a first type.

In one embodiment, a first sub-signal is a sub-signal transmitted in a first time window in the first sub-signal set, and the first time window is any second-type time window in the second time window set; a redundancy version (RV) of the first sub-signal is related to an index of the first time window.

In one embodiment, a given sub-signal is any sub-signal in the first sub-signal set, and a transmitter of the first sub-signal set maintains power consistency on the given sub-signal.

In one embodiment, a second time window and a third time window are respectively two second-type time windows in the second time window set, and the second time window and the third time window belong to a same first-type time window in the first time window set; a second sub-signal and a third sub-signal are respectively sub-signals transmitted in the second time window and the third time window in the first sub-signal set; the second sub-signal and the third sub-signal are not quasi co-located.

In one embodiment, a first sub-signal is a sub-signal transmitted in a first time window in the first sub-signal set, and the first time window is any second-type time window in the second time window set; a first power parameter set is used to calculate transmit power of the first sub-signal; the first power parameter set is related to whether the first time window comprises a symbol belonging to the first time-domain resource or a symbol belonging to the second time-domain resource.

In one embodiment, the second transmitter transmits a reference signal in P0 reference signal resources; any second-type time window in the second time window set corresponds to one of the P0 reference signal resources, where PG is a positive integer greater than 1.

In one embodiment, the second node receives and transmits radio signals in the first time-domain resource simultaneously; the second node receives a radio signal in the second time-domain resource; the second node receives and transmits radio signals at different times in the second time-domain resource; the given first-type time window is any first-type time window whose remaining number of symbols is greater than a first threshold after excluding symbols belonging to an invalid symbol set in the first time window set; the first threshold is a non-negative integer; any second-type time window in the second time window set satisfies a first condition; the first condition comprises: all comprised symbols being continuous in time domain, all comprised symbols belonging to a same slot, and comprising symbols belonging to only one time-domain resource in the first time-domain resource and the second time-domain resource.

In one embodiment, the given first-type time window is any first-type time window whose remaining number of symbols is greater than a first threshold after excluding symbols belonging to an invalid symbol set in the first time window set; the first threshold is a non-negative integer; any second-type time window in the second time window set satisfies a first condition; the first condition comprises: all comprised symbols being continuous in time domain, all comprised symbols belonging to a same slot, and comprising symbols belonging to only one time-domain resource in the first time-domain resource and the second time-domain resource.

In one embodiment, the second node is a base station.

In one embodiment, the second node is a UE.

In one embodiment, the second node is a relay node.

In one embodiment, the second transmitter 1601 comprises at least one of the antenna 420, the transmitter 418, the transmitting processor 416, the multi-antenna transmitting processor 471, the controller/processor 475, or the memory 476 in Embodiment 4.

In one embodiment, the second receiver 1602 comprises at least one of the antenna 420, the receiver 418, the receiving processor 470, the multi-antenna receiving processor 472, the controller/processor 475, or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling and a second signaling, the first signaling being used to determine a first time-domain resource, the second signaling being used to determine a first time window set; and
a first transmitter, transmitting a first sub-signal set, the first sub-signal set comprising at least one sub-signal, and any sub-signal in the first sub-signal set carrying a first bit block;
wherein the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

2. The first node according to claim 1, wherein the first signaling configures a symbol in the first time-domain resource as a first type.

3. The first node according to claim 1, wherein a transmitter of the first signaling receives and transmits radio signals in the first time-domain resource simultaneously.

4. The first node according to claim 1, wherein a first sub-signal is a sub-signal transmitted in a first time window in the first sub-signal set, and the first time window is any second-type time window in the second time window set; a redundancy version (RV) of the first sub-signal is related to an index of the first time window.

5. The first node according to claim 1, wherein a given sub-signal is any sub-signal in the first sub-signal set, and the first node maintains power consistency on the given sub-signal.

6. The first node according to claim 1, wherein a second time window and a third time window are respectively two second-type time windows in the second time window set, and the second time window and the third time window belong to a same first-type time window in the first time window set; a second sub-signal and a third sub-signal are respectively sub-signals transmitted in the second time window and the third time window in the first sub-signal set; the second sub-signal and the third sub-signal are not quasi co-located.

7. The first node according to claim 1, wherein a first sub-signal is a sub-signal transmitted in a first time window in the first sub-signal set, and the first time window is any second-type time window in the second time window set; a first power parameter set is used to calculate transmit power of the first sub-signal; the first power parameter set is related to whether the first time window comprises a symbol belonging to the first time-domain resource or a symbol belonging to the second time-domain resource.

8. A second node for wireless communications, comprising:
a second transmitter, transmitting a first signaling and a second signaling, the first signaling being used to determine a first time-domain resource, the second signaling being used to determine a first time window set; and
a second receiver, receiving a first sub-signal set, the first sub-signal set comprising at least one sub-signal, and any sub-signal in the first sub-signal set carrying a first bit block;
wherein the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

9. The second node according to claim 8, wherein the first signaling configures a symbol in the first time-domain resource as a first type;
or, the second node receives and transmits radio signals in the first time-domain resource simultaneously.

10. The second node according to claim 8, wherein a first sub-signal is a sub-signal transmitted in a first time window in the first sub-signal set, and the first time window is any second-type time window in the second time window set; a redundancy version (RV) of the first sub-signal is related to an index of the first time window.

11. The second node according to claim 8, wherein a given sub-signal is any sub-signal in the first sub-signal set, and a transmitter of the first sub-signal set maintains power consistency on the given sub-signal.

12. The second node according to claim 8, wherein a second time window and a third time window are respectively two second-type time windows in the second time window set, and the second time window and the third time window belong to a same first-type time window in the first time window set; a second sub-signal and a third sub-signal are respectively sub-signals transmitted in the second time window and the third time window in the first sub-signal set; the second sub-signal and the third sub-signal are not quasi co-located.

13. The second node according to claim 8, wherein a first sub-signal is a sub-signal transmitted in a first time window in the first sub-signal set, and the first time window is any second-type time window in the second time window set; a first power parameter set is used to calculate transmit power of the first sub-signal; the first power parameter set is related to whether the first time window comprises a symbol belonging to the first time-domain resource or a symbol belonging to the second time-domain resource.

14. A method in a first node for wireless communications, comprising:
receiving a first signaling, the first signaling being used to determine a first time-domain resource;
receiving a second signaling, the second signaling being used to determine a first time window set; and
transmitting a first sub-signal set, the first sub-signal set comprising at least one sub-signal, and any sub-signal in the first sub-signal set carrying a first bit block;
wherein the first time window set comprises at least one first-type time window; the first time window set is used to determine a second time window set, and the second time window set comprises at least one second-type time window; each sub-signal in the first sub-signal set is transmitted in a second-type time window in the second time window set; a given first-type time window is a first-type time window in the first time window set, the given first-type time window comprises one or more second-type time windows in the second time window set; how many second-type time windows in the second time window set are comprised by the given first-type time window is related to whether the given first-type time window comprises both a symbol belonging to the first time-domain resource and a symbol belonging to the second time-domain resource; the first time-domain resource and the second time-domain resource are orthogonal to each other; any second-type time window in the second time window set comprises a symbol belonging to only the first time-domain resource in the first time-domain resource and the second time-domain resource or a symbol belonging to only the second time-domain resource in the first time-domain resource and the second time-domain resource.

15. The method in a first node according to claim 14, wherein the first signaling configures a symbol in the first time-domain resource as a first type.

16. The method in a first node according to claim 14, wherein a transmitter of the first signaling receives and transmits radio signals in the first time-domain resource simultaneously.

17. The method in a first node according to claim 14, wherein a first sub-signal is a sub-signal transmitted in a first time window in the first sub-signal set, and the first time window is any second-type time window in the second time window set; a redundancy version (RV) of the first sub-signal is related to an index of the first time window.

18. The method in a first node according to claim 14, wherein a given sub-signal is any sub-signal in the first sub-signal set, and the first node maintains power consistency on the given sub-signal.

19. The method in a first node according to claim 14, wherein a second time window and a third time window are respectively two second-type time windows in the second time window set, and the second time window and the third time window belong to a same first-type time window in the first time window set; a second sub-signal and a third sub-signal are respectively sub-signals transmitted in the second time window and the third time window in the first sub-signal set; the second sub-signal and the third sub-signal are not quasi co-located.

20. The method in a first node according to claim 14, wherein a first sub-signal is a sub-signal transmitted in a first time window in the first sub-signal set, and the first time window is any second-type time window in the second time window set; a first power parameter set is used to calculate transmit power of the first sub-signal; the first power parameter set is related to whether the first time window comprises a symbol belonging to the first time-domain resource or a symbol belonging to the second time-domain resource.
